(19) United States
(12) Patent Application Publication
(10) Pub. No.: US 2023/0340262 A1
(43) Pub. Date: Oct. 26, 2023

(54) COMPOSITIONS AND ARTICLES COMPRISING BLENDS INCLUDING BRANCHED POLYAMIDE

(71) Applicant: AdvanSix Resins & Chemicals LLC, Parsippany, NJ (US)

(72) Inventors: Veera Nelliappan, Richmond, VA (US); David J. Loy, Richmond, VA (US); Farzaneh Talebi, Midlothian, VA (US); Simon J. Porter, Chesterfield, VA (US); Ann M. Schoeb, Lebanon, NJ (US)

(21) Appl. No.: 18/022,156

(22) PCT Filed: Aug. 19, 2021
(86) PCT No.: PCT/US2021/046689

§ 371 Date: Feb. 19, 2023

Related U.S. Application Data
(60) Provisional application No. 63/068,254, filed on Aug. 20, 2020.

(51) Int. Cl. C08L 77/10

(52) U.S. Cl. CPC C08L 77/10; C08L 2203/12; C08L 2203/16; C08L 2203/202; C08L 2205/02; C08L 2205/03; C08L 2207/066

(57) ABSTRACT

The present disclosure provides compositions and articles including polyamide-6 or low-density polyethylene and a branched polyamide.

### CROSS-REFERENCE TO RELATED APPLICATION

This application claims priority to U.S. Provisional Application No. 63/068,254, filed Aug. 20, 2020, the entirety of which is incorporated by reference herein.

### TECHNICAL FIELD

The present disclosure relates to articles made using polyamides. In particular, the disclosure relates to articles made using blends including branched polyamides to achieve desirable properties such as high puncture resistance, tensile strength, and oxygen transmission rate, as well as low water vapor transmission rate.

### BACKGROUND

Typically, polyamides are formed from precursors such as caprolactam via hydrolysis, polyaddition, and polycondensation reactions. For polyamide-6 materials formed from caprolactam, hydrolysis opens the ring of the caprolactam monomer forming two end groups — one amine end group and one carboxyl end group, polyaddition combines caprolactam monomers into intermediate molecular weight oligomers, and polycondensation combines oligomers into higher molecular weight polymers.

As shown in Reaction 1 below, the polycondensation reaction includes a reversible chemical reaction in which oligomers or prepolymers of polyamide-6 form high molecular weight polyamide chains with water as an additional product. Polycondensation occurs simultaneously with hydrolysis and polyaddition and, as the reaction proceeds to form higher molecular weight polyamide chains, a decrease in the total number of end groups present occurs.

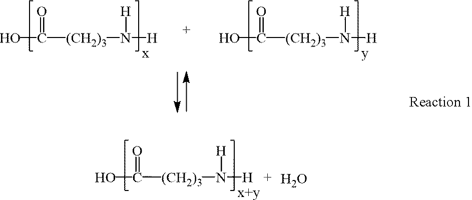

Water content affects the molecular weight of the resulting polyamide chains and the total number of end groups. By removing water, the reaction proceeds toward the production of higher molecular weight polymer chains to maintain the equilibrium of the reaction. In one technique, an increasing amount of vacuum is applied to remove water from the reaction products when significantly greater molecular weight polyamides are desired. However, application of an increasingly high vacuum is not practical over extended time periods as water becomes increasingly scarce within the mixture and is thereby harder to extract over time.

Articles formed from polyamide can include films, fibers, and wires, for example. The strength of the articles can be significantly enhanced by increasing the molecular weight of the polyamide. However, due to the difficulty in removing water as the molecular weight increases, commercially available high-molecular weight polyamides may be limited to a number average molecular weight (Mn) in the range of about 27 — 30 kilodaltons (kDa).

Furthermore, as the molecular weight of the polyamide polymer increases during the polycondensation reaction, the viscosity of the polymer also increases. As the viscosity increases, the pressure required for extrusion forming of the articles can exceed the limits of extrusion systems such as high-speed spinning systems for fibers, extruders for wires and blown extrusion systems for films, as is known in the art. Thus, there is a balance between managing higher molecular weight to produce articles of higher strength polyamide and ability to efficiently produce such polyamide articles in view of the increase melt viscosities associated with higher molecular weight polyamide.

### SUMMARY

The present disclosure provides compositions and articles including polyamide-6 or low-density polyethylene and a branched polyamide.

In one form thereof, the present disclosure provides a composition including a blend of polyamide-6 and a branched polyamide.

The branched polyamide of the composition may have the following formula:

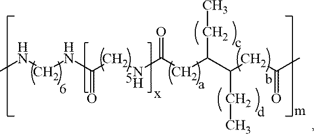

wherein a = 6 to 10, b = 6 to 10, c = 4 to 10, d = 4 to 10, x = 80 to 400 and m = 1 to 400. The branched polyamide may be present in an amount from 5 wt.% to 50 wt.% of the total weight of the blend of the polyamide-6 and the branched polyamide. The branched polyamide may be present in an amount from 15 wt.% to 25 wt.% of the total weight of the blend of the polyamide-6 and the branched polyamide. The branched polyamide may include one or more monofunctional terminating agent residues or bifunctional terminating agent residues. The one or more terminating agent residues may include a monofunctional acid residue, a bifunctional acid residue, a monofunctional amine residue and a bifunctional amine residue. A concentration of the amine end group may be less than 25 mmol/kg, and a concentration of the carboxyl end group may be less than 18 mmol/kg.

The branched polyamide of the composition may have a viscosity from 20 to 80 FAV. The polyamide-6 may have a viscosity from 80 to 140 FAV. The blend may consist essentially of the polyamide-6 and the branched polyamide. The blend may consist of the polyamide-6 and the branched polyamide.

In another form thereof, the present disclosure provides composition including a blend of low-density polyethylene and a branched polyamide.

The branched polyamide of the composition may have the following formula:

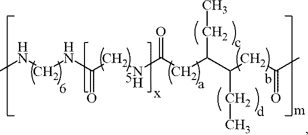

wherein a = 6 to 10, b = 6 to 10, c = 4 to 10, d = 4 to 10, × = 80 to 400 and m = 1 to 400. The branched polyamide may be present in an amount from 5 wt.% to 30 wt.% of the total weight of the blend of the polyethylene and the branched polyamide. The branched polyamide may include one or more monofunctional terminating agent residues or bifunctional terminating agent residues. The blend may consist essentially of the polyethylene and the branched polyamide. The blend may consist of the polyethylene and the branched polyamide.

In another form thereof, the present disclosure provides an article formed from the compositions disclosed herein.

The article may be a film. The article may be a fiber. The article may be a wire.

The article may be a film having less haze than a film including a composition comprising a blend of the low-density polyethylene and polyamide-6. The article may be a film having a tensile strength greater than a film consisting of polyamide-6 and a film consisting of the branched polyamide. The film may have a tensile strength in the machine direction that is greater than a film consisting of polyamide-6 and a film consisting of the branched polyamide. The article may be a film having a penetration to break greater than a film consisting of polyamide-6 and a film consisting of the branched polyamide. The article may be a film having a force to puncture greater than a film consisting of polyamide-6. The article may be a film having an elongation at break greater than a film consisting of polyamide-6. The article may be a film having an oxygen transmission rate greater than a film consisting of polyamide-6. The article may be a film having a water vapor transmission rate greater than a film consisting of polyamide-6. The article may be used as a cut flower or produce packaging film.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a graph illustrating the enthalpy of melting for blends of branched or unbranched polyamides with LDPE, according to this disclosure.

FIG. 2 is a graph illustrating the tensile strength of polyamide films, including a blend of polyamide-6 and a branched polyamide, according this disclosure.

FIG. 3 is a graph illustrating the elongation of polyamide films, including a blend of polyamide-6 and a branched polyamide, according this disclosure.

FIG. 4 is graph illustrating the tensile strength of polyamide films, including a blend of polyamide-6 and branched polyamides, according this disclosure.

FIG. 5 is graph illustrating the penetration to break of polyamide films, including a blend of polyamide-6 and branched polyamides, according this disclosure.

FIG. 6 is graph illustrating the force to puncture of polyamide films, including a blend of polyamide-6 and branched polyamides, according this disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

The present disclosure provides compositions and articles including a blend of a branched polyamide and another polymer, such as polyamide-6 or low-density polyethylene. It has been surprisingly found that articles, such as films, fibers, and wires, formed from blends of branched polyamides and polyamide-6 can have improved properties over either the branched polyamide or polyamide-6 alone. Importantly, the pressure to extrude the polyamide to form articles is much lower because the branched polyamide can have a lower molecular weight, such as from 15-25 kDa.

The present disclosure provides compositions and articles including a blend of a branched polyamide and polyamide-6. The branched polyamide includes dimer acid residues. The dimer acid residues provide branching structures to the polyamide. Branched polyamides exhibit similar characteristics to higher molecular weight linear polyamides. Without wishing to be bound by any theory, it is believed that interactions between branches cause the polyamide to display increased strength. It is also believed that the branched polyamide is relatively hydrophobic, and an article comprising the branched polyamide may absorb a relatedly low amount of water and display a relatively low water vapor transmission rate (WVTR). Additionally, it is also believe that the interactions between the branches of the branched polyamide contributes to increased free volume between the polyamide monomers, and therefore, may allow for a relatively higher rate of molecular diffusion through an article comprising the branched polyamide.

As known in the art, a polymer blend is a composition in which at least two polymers are blended or mixed together to create a new material with different physical properties.

The present disclosure provides a composition comprising a blend of polyamide-6 and a branched polyamide. In compositions comprising a blend of polyamide-6 and any of the branched polyamides described herein, the branched polyamide may be present in an amount as low as 5 weight percent (wt.%), 10 wt. %, 15 wt. %, 20 wt. % or 25 wt. %, or as high as 30 wt. %, 35 wt. %, 40 wt. %, 45 wt. % or 50 wt. %, or within any range defined between any two of the foregoing values, such as 5 wt.% to 50 wt. %, 10 wt. % to 45 wt. %, 15 wt. % to 40 wt. %, 20 wt. % to 35 wt. %, 25 wt. % to 30 wt. %, 20 wt. % to 40 wt. %, 25 wt. % to 35 wt. %, 15 wt. % to 25 wt. % or 10 wt. % to 30 wt. %, for example. All weight percentages are based on the total weight of the blend of polyamide-6 and the branched polyamide.

The blend may consist essentially of polyamide-6 and the branched polyamide. The blend may consist of polyamide-6 and the branched polyamide. The polyamide-6, also known as Nylon-6 or polycaprolactam, is commercially available. For example, Aegis® H100ZP Nylon 6 Extrusion Grade Homopolymer can be obtained from AdvanSix Inc., Parsippany, NJ. Aegis® H100ZP (H100ZP) is a medium viscosity polymer for cast or blown films and has a formic acid viscosity (FAV) of about 100. Another example is Aegis® H135ZP Nylon 6 Extrusion Grade Homopolymer, also available from AdvanSix Inc., Parsippany, NJ. Aegis® H135ZP (H135ZP) is a high viscosity polymer for cast or blown films and has a formic acid viscosity (FAV) of about 135. Yet another example is Aegis® H35ZP Nylon 6 Extrusion Grade Homopolymer, also available from AdvanSix Inc., Parsippany, NJ. Aegis® H35ZP (H35ZP) is a low molecular weight and relatively low viscosity nylon 6 homopolymer for cast or blown films and has a formic acid viscosity (FAV) of about 40. A further example is Aegis® H95ZP Nylon 6 Extrusion Grade Homopolymer, also available from AdvanSix Inc., Parsippany, NJ. Aegis® H95ZP (H95ZP) is a medium molecular weight, intermediate viscosity nylon 6 homopolymer for cast or blown films and has a formic acid viscosity (FAV) of about 90.

The polyamide-6 may have a formic acid viscosity as low as 80 FAV, 85 FAV, 90 FAV, 95 FAV, 100 FAV, 105 FAV or 110 FAV, or as high as 115 FAV, 120 FAV, 125 FAV, 130 FAV, 135 FAV or 140 FAV, or within any range defined between any two of the foregoing values, such as 80 FAV to 140 FAV, 85 FAV to 135 FAV, 90 FAV to 130 FAV, 9 5FAV to 125 FAV, 100 FAV to 120 FAV, 105 FAV to 115 FAV, 100 FAV to 135 FAV, 95 FAV to 140 FAV, 80 FAV to 110 FAV, or 115 FAV to 135 FAV, for example.

The branched polyamide be according to the following formula:

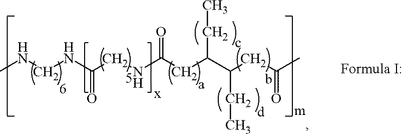

wherein a = 6 to 10, b = 6 to 10, c = 6 to 10, d = 6 to 10, m = 1 to 400 and x = 80 to 400. It is understood that the polyamide described by Formula I is a random copolymer.

The branched polyamide may be formed from caprolactam and one or more diamines. Also included are one or more dimer acids to provide the branching structures, and, optionally, one or more terminating agents, as described below. The resulting branched polyamides include a residue of the caprolactam, a residue of the diamine, a residue of the dimer acid and, optionally, a residue of the one or more terminating agents.

The caprolactam (also called hexano-6-lactam, azepan-2-one, and ε-caprolactam) is shown below:

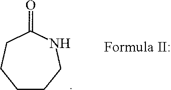

The diamine can be a C4-C6 straight or branched diamine, for example. The diamine can include hexamethylenediamine available from Sigma-Aldrich Corp, St. Louis, MO, for example.

The branched polyamide composition can include the residue of the diamine in an amount as low as 1 wt.%, 1.2 wt.%, 1.5 wt.%, 1.8 wt.%, 2 wt.%, 2.2 wt. %, 2.5 wt. %, 2.8 wt. % or 3 wt. %, or as high as 3.2 wt. %, 3.5 wt. %, 3.8 wt. %, 4 wt.%, 4.2 wt.%, 4.5 wt.%, 4.8 wt.% or 5 wt.%, or within any range defined between any two of the foregoing values, such as 1 wt.% to 5 wt.%, 1.2 wt.% to 4.8 wt.%, 1.5 wt. % to 4.5 wt. %, 1.8 wt. % to 4.2 wt. %, 2 wt. % to 4 wt. %, 2.2 wt. % to 3.8 wt. %, 2.5 wt. % to 3.5 wt. %, 2.8 wt. % to 3.2 wt. %, 1 wt. % to 3 wt. %, 2 wt. % to 4.5 wt. %, or 3.2 wt.% to 5 wt.%, for example. All weight percentages are based on the total weight of the branched polyamide.

The dimer acid can be as shown below:

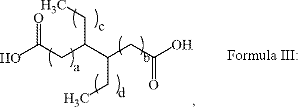

wherein a and b can each independently range from 6 to 10 and c and d can each independently range from 4 to 10. The dimer acid may be saturated or may include one or more unsaturated bonds. Two carbon chains, identified by the carbon atom counts c and d in Formula III, branch off the main polymer chain, as shown in Formula I, thus making the polymer composition of Formula I a branched polyamide composition. The two branching carbon chains may each have from 6-10 carbon atoms. It has been found that a branched polyamide composition with short chain (10 or fewer carbons) branching blended with polyamide-6 can exhibit increased tensile strength, in comparison to the polyamide-6 alone. The branching is believed to make the branched polyamide behave like a polyamide having a much higher molecular weight, resulting in higher tensile strength, higher penetration to break, and greater puncture strength.

Additionally, it is believed that the branching of the branched polyamide also contributes to increased free volume between the polyamide monomers of a blended composition of branched polyamide and polyamide-6. In this case, the additional free volume is believed to allow for some molecules to more readily pass through the blended composition, as compared to polyamide-6 alone. Oxygen transmission rate (OTR) is defined as the steady state rate at which oxygen gas permeates through a film at specified conditions of temperature and relative humidity. In the case of an article (e.g., film) comprising the blended composition of branched polyamide and polyamide-6, a higher rate of oxygen transmission through the film is observed as compared to polyamide-6 alone, which is believed to be due to the increased free volume between the polyamide monomers. Therefore, articles (e.g., films) comprising such blended compositions of branched polyamide and polyamide-6 may exhibit a higher OTR than a film comprising polyamide-6 alone.

It is also believed that the branched polyamide is more hydrophobic than polyamide-6. In this case, a blended composition of branched polyamide and polyamide-6 may display less water absorption than a composition of polyamide-6 alone. Water vapor transmission rate (WVTR) is the steady state rate at which water vapor permeates through a film at specified conditions of temperature and relative humidity. In the case of an article (e.g., film) comprising the blended composition of branched polyamide and polyamide-6, a lower rate of water transmission through the film is observed as compared to polyamide-6 alone, which is believed to be due to the hydrophobic nature of the branched polyamide. Therefore, articles (e.g., films) comprising such blended compositions of branched polyamide and polyamide-6 may exhibit a lower WVTR than a film comprising polyamide-6 alone. This is surprising in that the increased free volume between the polyamide monomers of the blended composition is overcome by the hydrophobic nature of the branched polyamide, whereas it would have been expected that water vapor transmission rate of the blended composition would also have been greater than polyamide-6 alone, since the free volume of the blended composition is greater than that of polyamide-6.

A film produced from such blended compositions of branched polyamide and polyamide-6 may be advantageous in the context of packaging, and particularly floral and produce packaging, and more specifically, fruit packaging and/or cut/fresh flower packaging. Desirable fruit and/or cut/fresh cut flower packaging materials exhibit high strength, high oxygen permeability, and high water retention. As described previously, the blended composition of the branched polyamide and polyamide-6 displays higher tensile strength, higher penetration to break, greater puncture strength, higher oxygen transmission rate, and lower water vapor transmission rate than polyamide-6 alone. Therefore, a film comprising the blended composition of branched polyamide and polyamide-6 may be particularly useful, among other uses, for produce packaging, particularly in the fruit packaging context, as well as floral packaging, particularly in the fresh/cut flower packaging context, since such a blended film is stronger, more oxygen permeable, and retains more water vapor, than nylon-6 alone.

The dimer acid, also called a dimerized fatty acid, is a dicarboxylic acid prepared by dimerizing an unsaturated fatty acid. Additional information about dimer acids can be found in Kirk-Othmer Encyclopedia of Chemical Technology, Volume 2, pp. 1-13. The dimer acid can include Pripol™ 1013 available from Croda International Plc, Edison, NJ, or a C36 dimer acid available from The Chemical Company, Jamestown, RI, for example.

The branched polyamide can include the residue of the dimer acid in an amount as low as 1 wt.%, 2 wt.%, 5 wt.%, 8 wt.%, 12 wt.% or 15 wt.%, or as high as 18 wt.%, 20 wt.%, 22 wt.%, 25 wt.%, 28 wt.%, or 30 wt.%, or within any range defined between any two of the foregoing values, such as 1 wt.% to 30 wt.%, 2 wt.% to 28 wt.%, 5 wt.% to 25 wt. %, 8 wt.% to 22 wt. %, 10 wt. % to 20 wt. %, 12 wt.% to 18 wt. %, 15 wt.% to 20 wt. %, 10 wt. % to 15 wt.%, or 18 wt.% to 30 wt. %, for example. All weight percentages are based on the total weight of the branched polyamide.

The branched polyamide may have a formic acid viscosity as low as 20 FAV, 25 FAV, 30 FAV, 35 FAV, 40 FAV, 45 FAV or 50 FAV, or as high as 55 FAV, 60 FAV, 65 FAV, 70 FAV, 75 FAV or 80 FAV, or within any range defined between any two of the foregoing values, such as 20 FAV to 80 FAV, 25 FAV to 75 FAV, 30 FAV to 70 FAV, 35 FAV to 65 FAV, 40 FAV to 60 FAV, 45 FAV to 55 FAV, 40 FAV to 75 FAV, 35 FAV to 80 FAV, 20 FAV to 500 FAV, or 55 FAV to 75 FAV, for example.

The branched polyamide can optionally be mono-terminated or dual-terminated with monofunctional or bifunctional terminating agents. Increased levels of terminating agents lower the concentrations of reactive amine and/or carboxyl end groups. The use of terminating agents results in the termination, by chemical reaction, of a carboxyl end group or an amine end group, respectively. That is, one weight equivalent of a terminating agent will reduce the corresponding end group by one equivalent. The termination also affects the water content of the final polyamide polymer as compared to a polymer having the same molecular weight. The terminated polymer also has a lower water content than that of an unterminated polymer coinciding with the equilibrium dynamics of the reaction. Further, the end of a terminated polymer cannot undergo further polyaddition or polycondensation reactions and thus maintains its molecular weight and exhibits a stable melt viscosity which is important for extrusion process consistency.

The mono-terminated branched polyamide may include a residue of a carboxyl end group terminating agent or a residue of an amine end group terminating agent. The amine end group terminating agents can include monofunctional acids, such as acetic acid, propionic acid, benzoic acid, and/or stearic acid, and/or bifunctional acids, such as terephthalic acid and/or adipic acid, for example. The carboxyl end group terminating agents can include monofunctional amines, such as cyclohexylamine, benzylamine and/or polyether amines, and/or bifunctional amines, such as hexamethylenediamine and/or ethylenediamine, for example. Increased levels of end group terminating agents lower the concentrations of reactive amine and/or carboxyl end groups.

The mono-terminated branched polyamide may include the residue of the carboxyl end group terminating agent in an amount of as little as 0.1 wt.%, 0.2 wt.%, 0.3 wt.%, 0.4 wt. % or 0.5 wt.%, or as great as 0.6 wt.%, 0.7 wt.%, 0.8 wt.%, 0.9 wt.% or 1 wt.%, or within any range defined between any two of the foregoing values, such as 0.1 wt.% to 1 wt.%, 0.2 wt.% to 0.8 wt.%, 0.3 wt.% to 0.7 wt.%, 0.4 wt.% to 0.6 wt.%, 0.1 wt.% to 0.5 wt.% or 0.6 wt.% to 0.9 wt.%, for example. All weight percentages are based on the total weight of the branched, terminated polyamide, not including additional additives.

The mono-terminated polyamide may include the residue of amine end group terminating agent in an amount of as little as 0.1 wt.%, 0.2 wt.%, 0.3 wt.%, 0.4 wt. % or 0.5 wt.%, or as great as 0.6 wt.%, 0.7 wt.%, 0.8 wt.%, 0.9 wt. % or 1 wt.%, or within any range defined between any two of the foregoing values, such as 0.1 wt. % to 1 wt. %, 0.2 wt. % to 0.8 wt. %, 0.3 wt. % to 0.7 wt. %, 0.4 wt. % to 0.6 wt. %, 0.1 wt. % to 0.5 wt.% or 0.6 wt.% to 0.9 wt.%, for example. All weight percentages are based on the total weight of the branched, terminated polyamide, not including additional additives.

The dual-terminated polyamide may include a residue of a carboxyl end group terminating agent and residue of an amine end group terminating agent. The amine end group terminating agents and the carboxyl end group terminating agents are as described above.

The dual-terminated polyamide may include the residue of the carboxyl end group terminating agent in an amount of as little as 0.1 wt.%, 0.2 wt.%, 0.3 wt. %, 0.4 wt. % or 0.5 wt.%, or as great as 0.6 wt.%, 0.7 wt. %, 0.8 wt.%, 0.9 wt. % or 1 wt.%, or within any range defined between any two of the foregoing values, such as 0.1 wt.% to 1 wt.%, 0.2 wt.% to 0.8 wt.%, 0.3 wt.% to 0.7 wt.%, 0.4 wt.% to 0.6 wt.%, 0.1 wt.% to 0.5 wt.% or 0.6 wt.% to 0.9 wt.%, for example. All weight percentages are based on the total weight of the branched, terminated polyamide, not including additional additives.

The dual-terminated polyamide may include the residue of amine end group terminating agent in an amount of as little as 0.20 wt.%, 0.25 wt.%, 0.30 wt.% or 0.40 wt.%, or as great as 0.50 wt.%, 0.60 wt.%, 0.65 wt.%, 0.70 wt.%, or 1 wt. %, or within any range defined between any two of the foregoing values, such as 0.20 wt. % to 1 wt. %, 0.25 wt. % to 0.70 wt. %, 0.30 wt. % to 0.65 wt. %, 0.40 wt. % to 0.60 wt.%, 0.50 wt. % to 1 wt. % or 0.40 wt. % to 0.70 wt.%, for example. All weight percentages are based on the total weight of the branched, terminated polyamide, not including additional additives.

The branched, terminated polyamide may have a low moisture level as measured by ASTM D-6869-17. The moisture level may be less than about 2,000 ppm, less than about 1,500 ppm, less than about 1,200 ppm, less than about 1,000 ppm, less than about 800 ppm, less than about 600 ppm, less than about 500 ppm, or less than about 400 ppm, or less than a moisture content within any range defined between any two of the foregoing values. All weight percentages are based on the total weight of the branched, terminated polyamide, not including additional additives.

The branched polyamide can be synthesized by providing caprolactam, dimer acid, diamine and water to a reactor, mixing the reactants together in the reactor, and reacting the reactants within the reactor at a reaction temperature. The reactor may be under a reaction pressure during at least a portion of the reacting step. A vacuum may be applied to the reactor to remove water generated during the reacting step. The mixing may continue during at least a portion of the reacting step.

The reaction temperature may be as low as about 225° C., about 230° C., about 235° C., about 240° C., or about 245° C., or as high as about 250° C., about 255° C., about 260° C., about 270° C., about 280° C., about 290° C., or within any range defined between any two of the foregoing values, such as about 225° C. to about 290° C., about 230° C. to about 280° C., about 235° C. to about 270° C., about 230° C. to about 260° C., about 260° C. to about 280° C., about 230° C. to about 240° C., or about 260° C. to about 270° C., for example.

In the providing step, a condensation catalyst may be provided. Suitable condensation catalysts include hypophosphorous acid salt or sodium hypophosphite, for example. The condensation catalyst may be provided at a concentration as low as about 25 ppm, about 50 ppm, about 100 ppm or about 150 ppm, or as high as about 200 ppm, about 250 ppm, or about 300 ppm, or within any range defined between any two of the foregoing values, such as about 25 ppm to about 300 ppm, about 50 ppm to about 300 ppm, about 100 ppm to about 250 ppm, about 150 ppm to about 200 ppm, about 50 ppm to about 150 ppm, or about 150 ppm to about 250 ppm, for example. All weight percentages are based on the total weight of the branched, terminated polyamide, not including additional additives.

An amine end group terminating agent and/or a carboxyl end group terminating agent may optionally be added to the reactor along with the caprolactam, dimer acid, diamine and water to produce a branched, terminated polyamide as described above.

The branched, terminated polyamide will also include some remaining amine end groups and carboxyl end groups that are not terminated by the end group terminating agents. The extent of termination can be found by measuring the concentrations of the remaining amine end groups and carboxyl end groups, as describe below.

The amine end group concentration (AEG) may be determined by the amount of hydrochloric acid (HCl standardized, 0.1 N) required to titrate a sample of the polyamide composition in solvent of 70% phenol and 30 % methanol according to Equation 1 below:

$$A E G = \frac{\left(m L H C l t o t i t r a t e s a m p l e - m L H C l t o t r i t a t e b l a n k\right) \times \left(N o r m a l i t y H C l\right) \times 1000}{s a m p l e w e i g h t i n g r a m s .} \qquad \text{Equation 1:}$$

For example, the branched, terminated polyamide may have an amine end group concentration as low as 20 mmol/kg, 22 mmol/kg, 24 mmol/kg, 26 mmol/kg, 28 mmol/kg or 30 mmol/kg, or as high as 32 mmol/kg, 34 mmol/kg, 36 mmol/kg, 38 mmol/kg or 40 mmol/kg, or within any range defined between any two of the foregoing values, such as 20 mmol/kg to 40 mmol/kg, 22 mmol/kg to 38 mmol/kg, 24 mmol/kg to 36 mmol/kg, 26 mmol/kg to 34 mmol/kg, 28 mmol/kg to 32 mmol/kg, 20 mmol/kg to 30 mmol/kg or 20 mmol/kg to 24 mmol/kg, for example. Alternatively, the branched, terminated polyamide may be “highly terminated” and may have an amine end group concentration of less than less than 20 mmol/kg, less than 18 mmol/kg, less than 10 mmol/kg, less than 8 mmol/kg, less than 7 mmol/kg or less than 5 mmol/kg, or have an amine end group concentration that is within any range defined between any two of the foregoing values, such as between 5 mmol/kg and 20 mmol/kg, between 7 mmol/kg and 18 mmol/kg, or between 8 mmol/kg and 10 mmol/kg, for example.

The carboxyl end group (CEG) concentration can be determined by the amount of potassium hydroxide (KOH) needed to titrate a sample of the polyamide in benzyl alcohol according to the Equation 2 below:

$$C E G = \frac{\left(\text{mL} \text{KOH} \text{to} \text{titrate} \text{sample} - \text{mL KOH to titrate blank}\right) \times \left(\text{Normality KOH}\right) \times 1000}{\text{sample weight in grams}} \qquad \text{Equation 2:}$$

For example, the branched, terminated polyamide may have a carboxyl end group concentration as low as 20 mmol/kg, 22 mmol/kg, 24 mmol/kg, 26 mmol/kg, 28 mmol/kg or 30 mmol/kg, or as high as 32 mmol/kg, 34 mmol/kg, 36 mmol/kg, 38 mmol/kg or 40 mmol/kg, or within any range defined between any two of the foregoing values, such as 20 mmol/kg to 40 mmol/kg, 22 mmol/kg to 38 mmol/kg, 24 mmol/kg to 36 mmol/kg, 26 mmol/kg to 34 mmol/kg, 28 mmol/kg to 32 mmol/kg, 20 mmol/kg to 30 mmol/kg or 20 mmol/kg to 24 mmol/kg, for example. Alternatively, the branched, terminated polyamide may be “highly terminated” and may have a carboxyl end group concentration of less than 20 mmol/kg, less than 18 mmol/kg, less than 16 mmol/kg, less than 14 mmol/kg, less than 10 mmol/kg, less than 8 mmol/kg, less than 7 mmol/kg or less than 5 mmol/kg, or have a carboxyl end group concentration that is within any range defined between any two of the foregoing values, such between 5 mmol/kg and 20 mmol/kg, between 7 mmol/kg and 18 mmol/kg, or between 8 mmol/kg and 16 mmol/kg, for example.

Another way to measure levels of termination is by the degree of termination. The degree of termination of the branched, terminated polyamide can be determined using the following Equations:

$$\begin{matrix}\text{Total termination\%} \\ \text{=} \left[\frac{\text{Equilibrium NH2 + COOH ends for FAV level-Terminated NH2 + COOH ends}}{\text{Equilibrium NH2 + COOH ends for FAV level}}\right] \\ ∗ 100 \%\end{matrix} \qquad \text{Equation 3:}$$

$$\begin{matrix}\text{NH2 termination\%} \\ \text{=} \left[\frac{\text{Equilibrium NH2 ends for FAV level-Terminated NH2 ends}}{\text{Equilibrium NH2 ends for FAV level}}\right] \\ ∗ 100 \%\end{matrix} \qquad \text{Equation 4:}$$

$$\begin{matrix}\text{COOH termination\%} \\ \text{=} \left[\frac{\text{Equilibrium COOH ends for FAV level-Terminated COOH ends}}{\text{Equilibrium COOH ends for FAV level}}\right] \\ ∗ 100 \%\end{matrix} \qquad \text{Equation 5:}$$

A branched, terminated polyamide can have a total termination% of as low as 20%, 25%, 30%, 35%, 40%, 45%, or 50%, or as high as 55%, 60%, 65%, 70%, 75%, 80 %, 85% or 95%, or within any range defined between any two of the foregoing values, such as 20% to 90%, 25% to 85%, 30% to 80%, 35% to 75%, 40% to 70%, 45% to 65%, 50% to 60%, 55% to 60% or 20% to 60%, for example.

The present disclosure also provides compositions and articles including a blend of a branched polyamide and low-density polyethylene (LDPE). Low-density polyethylene is a widely commercially available polymer, commonly used in flexible packaging as a sealant material, for example. LDPE is generally considered to have a density of from 0.917 g/cm³ to 0.930 g/cm³.

The present disclosure also provides a composition comprising a blend of low-density polyethylene (LDPE) and a branched polyamide. In compositions comprising a blend of low-density polyethylene (LDPE) and any of the branched polyamides described herein, the branched polyamide may be present in an amount as low as 5 weight percent (wt.%), 10 wt.%, 15 wt.%, 20 wt.% or 25 wt.%, or as high as 30 wt. %, 35 wt. %, 40 wt. %, 45 wt.% or 50 wt. %, or within any range defined between any two of the foregoing values, such as 5 wt.% to 50 wt.%, 10 wt.% to 45 wt. %, 15 wt. % to 40 wt.%, 20 wt. % to 35 wt. %, 25 wt. % to 30 wt. %, 20 wt.% to 40 wt.%, 25 wt.% to 35 wt.%, 15 wt.% to 25 wt.% or 10 wt.% to 30 wt.%, for example. All weight percentages are based on the total weight of the blend of low-density polyethylene and the branched polyamide.

Similar to blended compositions of branched polyamide and polyamide-6, a branched polyamide composition with short chain (10 or fewer carbons) branching blended with LDPE may exhibit increased tensile strength, in comparison to the LDPE alone. The branching of the polyamide is believed to make the branched polyamide behave like a polyamide having a much higher molecular weight, resulting in higher tensile strength, higher penetration to break, and greater puncture strength.

Additionally, it is believed that the branching of the branched polyamide also contributes to increased free volume between the polyamide monomers of a blended composition of branched polyamide and LDPE. This additional free volume is believed to allow for some molecules to more readily pass through the blended composition, as compared to LDPE alone. In the case of an article (e.g., film) comprising the blended composition of branched polyamide and LDPE, a higher rate of oxygen transmission through the film may be observed, as compared to LDPE alone, which is believed to be due to the increased free volume between the polyamide monomers. Therefore, articles (e.g., films) comprising such blended compositions of branched polyamide and LDPE may exhibit a higher OTR than a film comprising LDPE alone.

It is also believed that the branched polyamide may be more hydrophobic than LDPE, and a blended composition of branched polyamide and LDPE may display less water absorption than LDPE alone. In the case of an article (e.g., film) comprising the blended composition of branched polyamide and LDPE, a lower rate of water transmission through the film may be observed as compared to LDPE alone, which may be due to the hydrophobic nature of the branched polyamide. Therefore, articles (e.g., films) comprising such blended compositions of branched polyamide and LDPE may exhibit a lower WVTR than a film comprising LDPE alone.

A film produced from a blended composition of branched polyamide and LDPE may be advantageous in the context of packaging, and particularly floral and/or produce packaging, and more specifically, fruit packaging and/or cut/fresh flower packaging. Desirable fruit and/or cut/fresh cut flower packaging materials exhibit high strength, high oxygen permeability, and high water retention. As described previously, the blended composition of the branched polyamide and LDPE may display higher tensile strength, higher penetration to break, greater puncture strength, higher oxygen transmission rate, and lower water vapor transmission rate than LDPE alone.

Articles including the blend of branched polyamides and polyamide-6 or low-density polyethylene described herein can include films, fibers, and wires. Films may be formed by extrusion blow molding, for example. Fibers may be formed by extrusion fiber spinning, for example. Wires may be formed by extrusion, for example.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### EXAMPLES

### Example 1 — Preparation of a Branched Polyamide (BPA)

In this Example, the preparation of a branched polyamide is demonstrated. A reactor was prepared by fitting a 12 L stainless-steel vessel with a helical agitator. The reactants provided to the reactor included 4,800 grams caprolactam (AdvanSix Resins and Chemicals LLC, Parsippany, NJ), 672 grams Pripol™ 1013 dimer acid (Croda Incorporated, Wilmington DE), and 195 grams of a solution consisting essentially of 70 wt.% hexamethylenediamine and 30 wt.% water (Sigma-Aldrich Corp., St. Louis, MO). A condensation catalyst was also provided to the reactor in the form of hypophosphorous acid salt at a concentration of about 50 parts per million, as well as 100 grams of deionized water.

The reactants, the catalyst and the water were mixed together in the reactor. The reactor was heated to a reaction temperature of about 230° C. and the reactants mixed for one hour. A reactor pressure of about 6 bars was observed. After the one hour, the reactor was vented to release the pressure. The reaction temperature was maintained at 230° C. and held for one hour while the reactor was swept with nitrogen (2 L/min) and the contents mixed with the helical agitator to allow the polyamide to grow in molecular weight. After four hours, the polyamide was extruded from the reactor and into a water trough to cool. The cooled polyamide was pelletized with a pelletizer to form chips of the polyamide. The chips were leached three times at 120° C. at a pressure of about 15 psi for one hour in deionized water for a total time of three hours to remove unreacted caprolactam. The rinsed polyamide was dried in a vacuum oven at 80° C. and a vacuum of 28 inches ofmercury to produce a polyamide composition with a moisture content of about 800 parts per million.

### Example 2 — Preparation of a Terminated, Branched Polyamide

In this Example, the preparation of a terminated, branched polyamide is demonstrated. A reactor was prepared by fitting a 12 L stainless-steel vessel with a helical agitator. The reactants provided to the reactor included 4,800 grams caprolactam (AdvanSix Resins and Chemicals LLC, Parsippany, NJ), 672 grams Pripol™ 1013 dimer acid (Croda Incorporated, Wilmington DE), 40 grams of stearic acid (Sigma-Aldrich Corp., St. Louis, MO), and 195 grams of a solution consisting essentially of 70 wt.% hexamethylenediamine and 30 wt.% water (Sigma-Aldrich Corp., St. Louis, MO). A condensation catalyst was also provided to the reactor in the form of hypophosphorous acid salt at a concentration of about 50 parts per million, as well as 100 grams of deionized water.

The reactants, the catalyst and the water were mixed together in the reactor. The reactor was heated to a reaction temperature of about 230° C. and the reactants mixed for one hour. A reactor pressure of about 6 bars was observed. After the one hour, the reactor was vented to release the pressure. The reaction temperature was maintained at 230° C. and held for one hour while the reactor was swept with nitrogen (2 L/min) and the contents mixed with the helical agitator to allow the polyamide to grow in molecular weight. After four hours, the polyamide was extruded from the reactor and into a water trough to cool. The cooled polyamide was pelletized with a pelletizer to form chips of the polyamide. The chips were leached three times at 120° C. at a pressure of about 15 psi for one hour in deionized water for a total time of three hours to remove unreacted caprolactam. The rinsed polyamide was dried in a vacuum oven at 80° C. and a vacuum of 28 inches of mercury to produce a polyamide composition with a moisture content of about 800 parts per million.

### Example 3 — Comparative Compatibility of Branched and Unbranched Polyamide with a Polyolefin

In this Example, the relative compatibility branched and unbranched polyamide with low-density polyethylene is compared. The branched polyamide of Example 1 is compared to an unterminated polyamide-6 without branching (Aegis® H85ZP, available from AdvanSix Incorporated).

Using an 18 mm twin-screw extruder, a strand of low-density polyethylene (LDPE) was made and subsequently pelletized. The LDPE was of the type commonly used in flexible packaging as a sealant material. The LDPE was blended with the branched polyamide (BPA) of Example 1 or pellets of the unbranched polyamide (PA), extruded and pelletized to produce pellets of 10 wt.% BPA, 15 wt.% BPA, 30 wt.% BPA, 10 wt.% PA and 30 wt.% PA, with the balance LDPE.

Monolayer films were prepared from a blend of 50 wt.% unprocessed LDPE and 50 wt.% of each of the LDPE, BPA and PA pellet groups to produce films consisting of 50 wt.% LDPE, 5 wt.% BPA, 7.5 wt.% BPA, 15 wt.% BPA, 5 wt.% PA and 15 wt.% PA, with the balance unprocessed LDPE. Films were also prepared from 100% unprocessed LDPE (LDPE that was not processed through the extruder as described above). The films were measured for haze. The results are shown in Table 1 below.

TABLE 1

| Composition | Haze (%) |
|---|---|
| Unprocessed LDPE | 5.2 ± 0.1 |
| 50 wt.% LDPE | 6.2 ± 0.1 |
| 5 wt.% BPA | 9.5 ± 0.2 |
| 5 wt.% PA | 15.6 ± 0.2 |
| 7.5 wt.% BPA | 11.0 ± 0.5 |
| 15 wt.% BPA | 16.0 ± 0.4 |
| 15 wt.% PA | 29.8 ± 0.9 |

It was surprisingly found that over the range of concentrations evaluated, the films made with the branched polyamide (BPA) consistently exhibited less haze than the films made with the unbranched polyamide (BPA) at the same concentrations. These results suggest that at this level, the branched polyamide is more compatible with the LDPE. Without wishing to be bound by any theory, it is thought that the branching side groups (olefinic side groups) might increase the compatibility of the branched polyamide with the polyolefin material (LDPE).

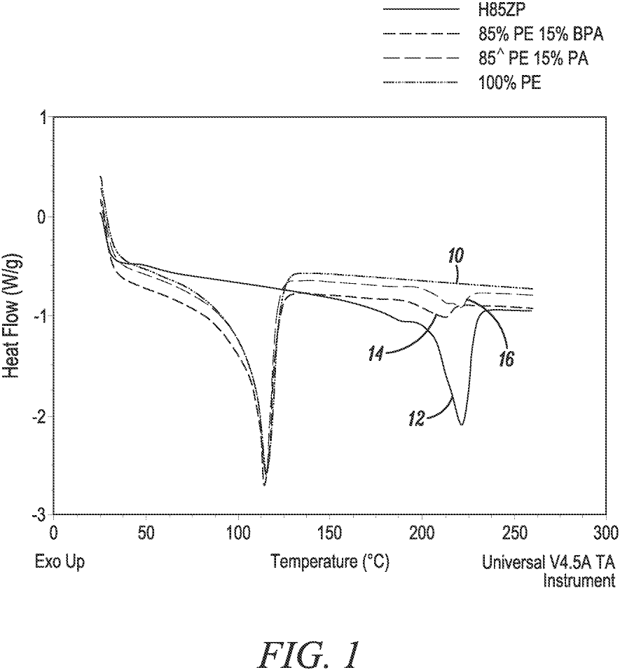

The compatibility effect of the BPA with the LDPE was further evaluated by comparing the enthalpy of melting of the blend of 15 wt.% BPA and 85 wt.% LDPE with the blend of 15 wt.% PA and 85 wt.% LDPE, as measured using differential scanning calorimetry (DSC). The LDPE alone and the PA alone were also measured by DSC. The results are shown in FIG. 1.

FIG. 1 shows the LDPE heat flow 10, the PA heat flow 12, the 85% wt.% LDPE/15 wt.% BPA heat flow 14 and the 85 wt.% LDPE/15 wt.% PA flow 16. The heat flow observed for the PA was 60 J/g (220° C.). Thus, the enthalpy of melting for the 15% blends was expected to be about 9 J/g (15% of the 60 J/g). However, the measure enthalpy of melting for the 15% BPA blend was 4 J/g. The difference of 5 J/g from the expected value may be accounted for by the missing polymer sections which become miscible with the LDPE. Without wishing to be bound by any theory, it is thought that less polar dimer acid sections which make up the branches in the BPA may account for the improved compatibility with the LDPE.

### Example 4 — Comparative Properties of Blends of Branched Polyamide and Medium Viscosity Unbranched Polyamide

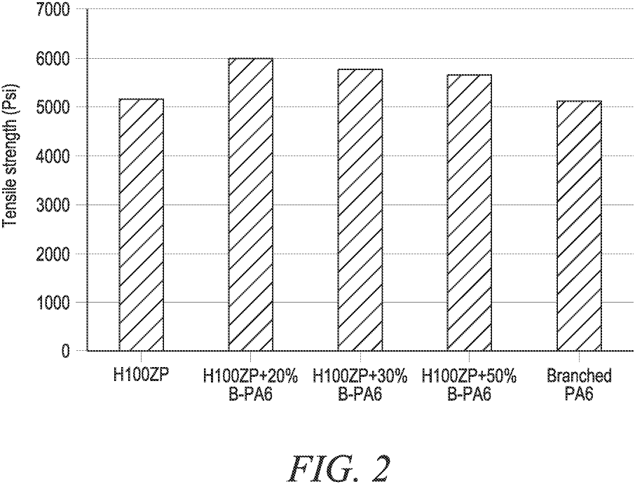

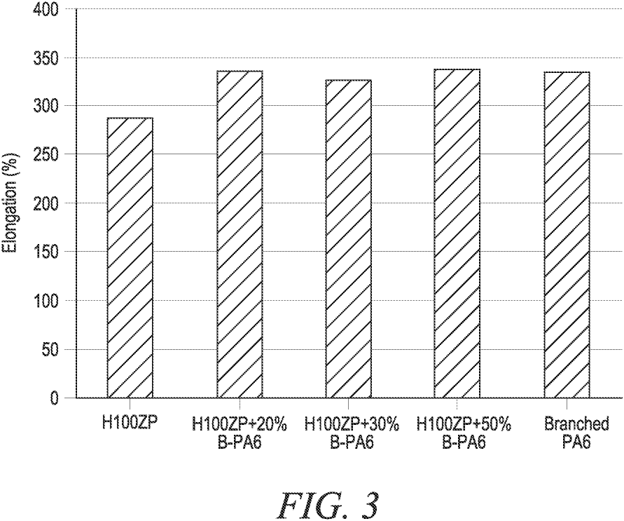

In this Example, the relative the tensile strength and elongation at break of the blends of the branched polyamide (designated here as B-PA6) of Example 1 and Aegis® H100ZP is compared. As noted above, H100ZP is a medium viscosity, unbranched polyamide-6. Monolayer films of blends of 20 wt.%, 30 wt.% and 50 wt.% BPA with the balance H100ZP were prepared. Films of 100% H100ZP and 100% BPA were also prepared. The tensile strength and elongation at break were measured on an Instron tester per ASTM D-822. Measurements in the machine direction and transverse direction were averaged. The tensile strength results are shown in FIG. 2 and the elongation at break results are shown in FIG. 3.

As shown in FIG. 2, the blends of the branched polyamide B-PA6) with the unbranched polyamide (H100ZP) surprisingly produced films with greater tensile strength than either the H100ZP alone or the B-PA6 alone. The blend with 20 wt.% of the B-PA6 in particular exhibited the highest tensile strength. As shown in FIG. 3, the elongation at break appears to be controlled almost entirely to the softness of the B-PA6, with the B-PA6 imparting improved elongation at break results.

### Example 5 — Comparative Properties of Blends of Terminated and Unterminated Branched Polyamide and High Viscosity Unbranched Polyamide

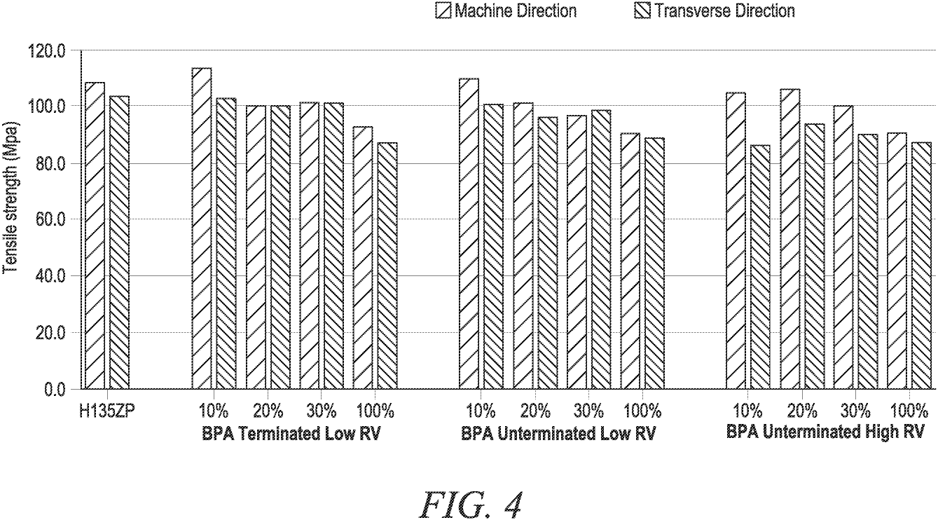

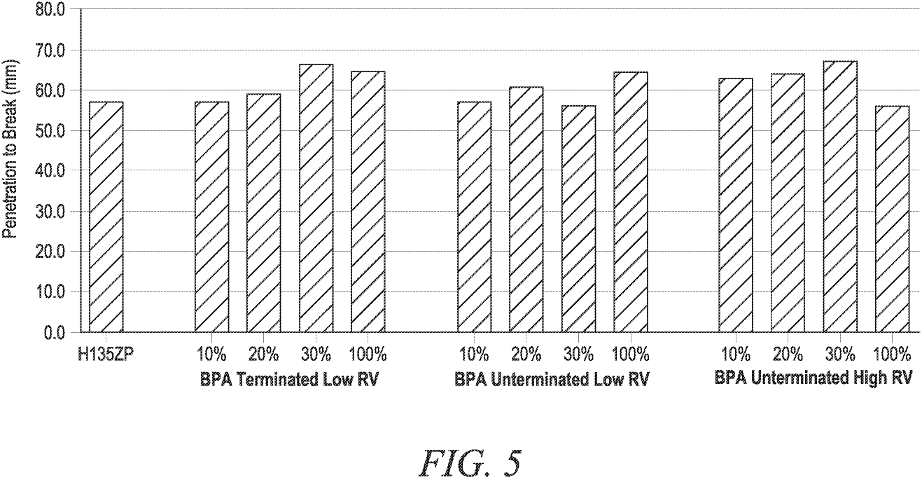

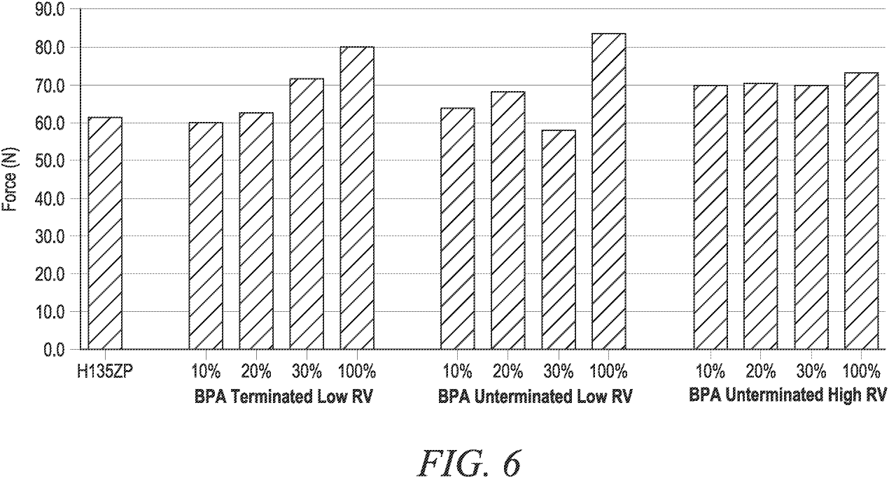

In this Example, the relative the tensile strength, penetration at break and puncture force of blends of the branched polyamide of Example 1 or the terminated, branched polyamide of Example 2, with Aegis® H135ZP are compared. As noted above, H135ZP is a high-viscosity, unbranched polyamide-6. The unterminated BPA of Example 1 was made both low relative viscosity (RV) and high RV versions. The terminated BPA of Example 2 was a low RV polyamide. Monolayer films of blends of 10 wt.%, 20 wt.% and 30 wt.% of BPA with the balance H135ZP were prepared for each of the BPA terminated low RV, the BPA unterminated low RV and the BPA unterminated high RV. Films of 100% H135ZP and 100% BPA (terminated low RV, unterminated low RV and unterminated high RV) were also prepared. The tensile strength results are shown in FIG. 4, the penetration at break results are shown in FIG. 5 and the puncture force results are shown in FIG. 6.

As shown in FIG. 4, surprisingly, the terminated and unterminated low RV BPA blends showed increased tensile strength in the machine direction at 10 wt.% concentrations over the H135ZP or the either BPA alone. In the machine direction at higher concentrations and in the transverse direction, the tensile strength was between the H135ZP and the BPA. The unterminated high RV BPA blends showed tensile strength between the H135ZP and the BPA in all cases, but with a surprising improvement at 20 wt. % over the 10 wt. % and 30 wt. % concentrations.

As shown in FIG. 5, the terminated low RV BPA blends showed increased penetration to break at 30 wt.%, greater than for either the H135ZP or the BPA alone. The unterminated low RV BPA blends exhibited a surprising improvement at 20 wt.% over the 10 wt.% and 30 wt.% concentrations. Surprisingly, the unterminated high RV BPA blends exhibited consistently greater penetration to break greater than for either the H135ZP or the BPA alone at all concentrations.

As shown in FIG. 6, the terminated low RV BPA blends showed increased force to puncture over the H135ZP alone at concentrations of 20 wt.% and 30 wt.%, intermediate between the H135ZP or the BPA alone. The unterminated low RV BPA blends exhibited a surprising improvement at 20 wt.% over the 10 wt.% and 30 wt.% concentrations. The unterminated high RV BPA blends exhibited consistently greater force to puncture than for the H135ZP alone at all concentrations. In all cases, the blends exhibited a force to puncture greater than the H135ZP alone, but not as great as the BPA alone.

Taken together, FIGS. 4-6 demonstrate that blends of the branched polyamide with unbranched polyamide-6 can produce surprising improvements in tensile strength and penetration to break while also increasing the puncture force of the films over the unbranched polyamide-6 alone.

### Example 6 — Comparative Properties of Blended Branched/Unbranched Polyamide and Unbranched Polyamide.

In this Example, oxygen transmission rates (OTR) and water vapor transmission Rates (WVTP) were compared for blended polyamide formulations versus pure polyamide-6 formulations. In each of these cases the blended compositions comprised the branched polyamide of Example 1 and Aegis® H95ZP, and the pure unbranched polyamide comprised Aegis® H95ZP. As noted above, H95ZP has a typical FAV measured at about 90 in viscosity, unbranched polyamide-6. Six cast monolayer films were prepared for the tests, three comprising 100% H95ZP and three comprising 15 wt% BPA and 85 wt% H95ZP.

Two OTR tests were performed on two sets of the monolayers, the first OTR test performed at 23° C. and 0% Relative Humidity (RH), and the second test performed at 23° C. and 80% RH. The OTR results were reported in cm³-mil/100 in²-Day, is illustrated below in Table 2.

TABLE 2

| Sample | OTR Test 1 | OTR Test 2 |
|---|---|---|
| 100% Aegis H95ZP | 2.61 | 3.03 |

As illustrated in Table 2, the free volume of the blended 15% - BPA/ 85- Aegis H95ZP composition showed a higher OTR, as compared with the 100% Aegis H95ZP r film, in both the first test at 0% RH and the second case at 80% RH. As described previously, the higher observed OTR rate for the blended composition is likely caused by the increased free-volume between each of the polyamide monomers of the blend, as compared to pure H95ZP.

A WVTR test was performed on one set of the monolayers at 37.8° C. and 100% RH. The WVTR was reported in g-mil/100 in²-day, as is illustrated below in Table. 3.

TABLE 3

| Sample | WVTR Test |
|---|---|
| 100% Aegis H95ZP | 57 |
| Blended 15% - BPA, 85- Aegis H95ZP | 17.6 |

As illustrated in Table 3, the hydrophobic nature of the BPA likely led to the lower observed WVTR of the blended 15% BPA/ 85% H95ZP film as compared with the 100% H95ZP film. This was a somewhat surprising result, as it may have been theorized that the increased free volume of the blended composition would have yielded a higher WVTR. However, the lower WVTR result for the blended composition suggests that the solubility of water in the branched material is the dominant effect, and as such, lower water solubility of the branched polyamide yields low water permeability of the blended composition.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A composition comprising a blend of:
polyamide-6; and
a branched polyamide.

2. The composition of claim 1, wherein the branched polyamide has the following formula: 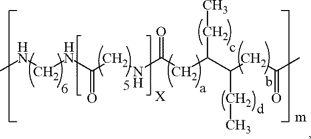
wherein a = 6 to 10, b = 6 to 10, c = 4 to 10, d = 4 to 10, x = 80 to 400 and m = 1 to 400.

3. The composition of claim 1,wherein the branched polyamide is present in an amount from 5 wt.% to 50 wt.% of the total weight of the blend of the polyamide-6 and the branched polyamide.

4. The composition of claim 1, wherein the branched polyamide is present in an amount from 15 wt.% to 25 wt.% of the total weight of the blend of the polyamide-6 and the branched polyamide.

5. The composition of claim 1, wherein the branched polyamide includes one or more monofunctional terminating agent residues or bifunctional terminating agent residues.

6. The composition of claim 5, wherein the one or more terminating agent residues include a monofunctional acid residue, a bifunctional acid residue, a monofunctional amine residue and a bifunctional amine residue.

7. The composition of claim 6, wherein a concentration of the amine end group is less than 25 mmol/kg, and a concentration of the carboxyl end group is less than 18 mmol/kg.

8. The composition of claim 1, wherein the branched polyamide has a viscosity from 20 to 80 FAV.

9. The composition of claim 1, wherein the polyamide-6 has a viscosity from 80 to 140 FAV.

10. The composition of claim 1, wherein the blend consists essentially of the polyamide-6 and the branched polyamide.

11. The composition of claim 1, wherein the blend consists of the polyamide-6 and the branched polyamide.

12. A composition comprising a blend of:
low-density polyethylene; and
a branched polyamide.

13. The composition of claim 12, wherein the branched polyamide has the following formula: 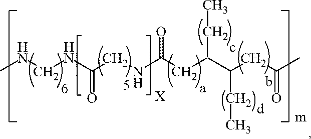
wherein a= 6 to 10, b = 6 to 10, c = 4 to 10, d = 4 to 10, x = 80 to 400 and m = 1 to 400.

14. The composition of claim 12, wherein the branched polyamide is present in an amount from 5 wt.% to 30 wt.% of the total weight of the blend of the polyethylene and the branched polyamide.

15. The composition of claim 12, wherein the branched polyamide includes one or more monofunctional terminating agent residues or bifunctional terminating agent residues.

16. The composition of claim 12, wherein the blend consists essentially of the polyethylene and the branched polyamide.

17. An article formed from the composition of claim 1.

18. The article of claim 17, wherein the article is a film.

19. The article of claim 17, wherein the article is a fiber.

20. The article of claim 17, wherein the article is a wire.

21. An article formed from the composition of claim 12, wherein the article is a film having less haze than a film including a composition comprising a blend of the low-density polyethylene and polyamide-6.

22. An article formed from the composition of claim 1, wherein the article is a film having a tensile strength greater than a film consisting of polyamide-6 and a film consisting of the branched polyamide.

23. The article of claim 22, wherein the film has a tensile strength in the machine direction that is greater than a film consisting of polyamide-6 and a film consisting of the branched polyamide.

24. An article formed from the composition of claim 1, wherein the article is a film having a penetration to break greater than a film consisting of polyamide-6 and a film consisting of the branched polyamide.

25. An article formed from the composition of claim 1, wherein the article is a film having a force to puncture greater than a film consisting of polyamide-6.

26. An article formed from the composition of claim 1, wherein the article is a film having an elongation at break greater than a film consisting of polyamide-6.

27. An article formed from the composition of claim 1, wherein the article is a film having an oxygen transmission rate greater than a film consisting of polyamide-6.

28. An article formed from the composition of claim 1, wherein the article is a film having a water vapor transmission rate greater than a film consisting of polyamide-6.

29. The article formed from the composition of claim 1, wherein the article is a produce and/or fresh/cut flower packaging film.

30. The article formed from the composition of claim 12, wherein the article is a produce and/or fresh/cut flower packaging film.
